(19) United States
(12) Patent Application Publication
(10) Pub. No.: US 2003/0040119 A1
(43) Pub. Date: Feb. 27, 2003

(54) Separation devices and methods for separating particles

(75) Inventors: Shuichi Takayama, Ann Arbor, MI (US); Dongeun Huh, Ann Arbor, MI (US); James Grotberg, Ann Arbor, MI (US)

Correspondence Address: MEDLEN & CARROLL, LLP, Suite 350, 101 Howard Street, San Francisco, CA, 94105, US

(73) Assignee: The Regents of The University of Michigan, Ann Arbor, MI

(21) Appl. No.: 10/117,690

(22) Filed: Apr. 5, 2002

Related U.S. Application Data
(60) Provisional application No. 60/283,047, filed on Apr. 11, 2001.

(51) Int. Cl. G01N 1/18; G01N 1/00

(52) U.S. Cl. 436/63; 436/177; 210/800

(57) ABSTRACT

The separation of particles in microchannels is described employing devices comprising sample inlets in liquid communication with microchannels, as well as adhesive separation regions, and simple detectors. Components can be fabricated by soft lithography into three dimensional devices, including embodiments with stacked channels separated by a membrane having pores.

### FIELD OF THE INVENTION

The present invention relates to microscale separating devices, methods for fabricating separating devices, and methods for separating particles in microscale devices.

### BACKGROUND

Separation of specific cells from a mixed cell population is important in medicine for biological and immunological measurements, and for use in cell therapy (e.g. transfusion medicine). For example, in the medical field, it is often necessary to filter blood. Whole blood is comprised of a liquid portion and a particle portion. The liquid portion of blood is largely made up of plasma and the particle portion is made up primarily of red blood cells, white blood cells and platelets. While these components have similar densities, their average density relationship, in order of decreasing density, is as follows: red blood cells, white blood cells, platelets, and plasma. When size is considered, the cells can be ordered according to decreasing size as follows: white blood cells, red blood cells, and platelets.

Most current approaches to the separation of blood elements involve centrifugation (distinguishing the cells based on density) or surface characteristics, whether in the context of light absorbing/reflecting properties or ligand binding properties. Platelets, for example, are usually separated by centrifugation. The blood enters a reservoir while it is rotating at a very rapid speed. The centrifugal force stratifies the blood components. Nonetheless, such procedures are typically not able to separate all of the white blood cells from the platelets. Moreover, the forces involved in separation of the cells can damage the final product, i.e. the separated platelets can be activated or even lysed during the process.

Cell labeling-based separation techniques, such as fluorescent activated cell droplet sorting, are also not well-suited to medical needs and therapies. Such approaches require that the cells be labeled prior to separation. In addition to being expensive and inconvenient, such pre-labeling can change the biochemistry of the cell. Furthermore, there is the problem of what is to be done with the label after the cell population is sorted. In most cases, labeled cells cannot be infused in patients and the harsh washing conditions necessary to remove the label can damage the cells.

Passive matrix-based separation techniques such as synthetic fiber filters have been employed in the separation of blood cells. However, these techniques have been found not to be sufficiently selective or adaptive for separation of specific cell types. Similarly, column chromatography and magnetic bead adsorption cannot separate cell subtypes quickly and cheaply.

Thus, there remains a need for an efficient separation system. Such a system should not employ centrifugal forces and should not require the labeling of cells prior to their separation.

### SUMMARY OF THE INVENTION

The present invention relates to microscale separating devices, methods for fabricating separating devices, and methods for separating particles in microscale devices. The present invention contemplates a microscale device (or “microsorter”), comprising elements linked in liquid communication, said elements comprising one or more sample inlet ports, one or more channels, and one or more detectors. The device is capable of sorting particles (including but not limited to cells) according to their microhydrodynamic characteristics such as particle size, shape, density, and deformability. The various components are compatible with various microscale systems. Moreover, the design is modular to permit the addition of other elements (e.g. outlets, cell collection chambers, etc.).

In one embodiment of the device, an sample inlet port or sample reservoir is linked to a vertically positioned (y axis) stream-focusing channel, said channel linked to a horizontally positioned (x axis) separating channel, said separating channel having an upper wall and a lower wall, said lower wall angled in relation to said upper wall such that said separating channel widens along the length of the channel. In operation, a liquid mixture of particles (e.g. cells) is introduced into the device via the sample inlet port and conveyed along a channel (e.g. via a pump such as a gravity pump) such that a stream of liquid is created in said stream-focusing channel, said stream thereafter entering the horizontally positioned separating channel. As the particles enter the horizontally positioned separating channel, the trajectories of the particles in the stream will start to deviate from the line of flow (due to gravitational accelerations) in a direction perpendicular to the direction of flow. “Small” particles will closely follow the line of flow whereas “large” particles will have a tendency to move towards the direction of gravitational acceleration. As the separating channel widens, the flow stream also widens, resulting in rapid sorting within short channel lengths (“separation amplification”).

When applied to cells, there are a number of features of the present invention that make the separating device and separating method for cell sorting more attractive than existing cell sorting methods, including: (i) the small size of the device (4 cm or less), ii) the compatibility with microfluidic devices, sensors, and labs-on-a-chip; (iii) the lack of a requirement for a power source for operation (since it can be run on gravity driven hydrostatic forces); (iv) the inexpensive and disposable nature of the device (as compared to large and expensive commercial FACS machines which can cost up to $300,000), (v) the lack of any prelabeling of cells with antibodies or magnetic beads; vi) the lack of strong shearing forces (e.g. such as those from a centrifuge); and (vii) the ability of the device to be quantitative (e.g. determine how many of each type of cells are present in the mixture).

In one embodiment, the present invention contemplates a device comprising a sample inlet in liquid communication with a first microchannel, said first microchannel in liquid communication with a second microchannel, said second microchannel having a length and height, said height increasing along said length. The present invention also contemplates a method of separating particles, comprising: a) providing: i) a device comprising a sample inlet in liquid communication with a first microchannel, said first microchannel in liquid communication with a second microchannel, said second microchannel having a length and height, said height increasing along said length; ii) a sample comprising a liquid mixture of first particles and second particles, said first and second particles being of different size; and b) introducing said sample into said device via said sample inlet under conditions such that a stream of liquid is generated in said first microchannel and said first and second particles are separated in said second microchannel. The stream is preferrably generated by conveying said liquid sample by gravity into said first microchannel. In one embodiment, the method further comprises, after step b), detecting said separated particles.

It is not intended that the present invention be limited by the nature of the sample. In one embodiment, said sample comprises a biological sample (e.g. the biological sample comprises blood cells).

In another embodiment, the present invention contemplates a method of separating particles, comprising: a) providing: i) a device comprising a sample inlet in liquid communication with a first microchannel, said first microchannel in liquid communication with a second microchannel, said second microchannel comprising a an adhesive sorting region defined by one or more ligands bound to said second microchannel; ii) a sample comprising a liquid mixture of first particles and second particles, said first and second particles being of different size; and b) introducing said sample into said device via said sample inlet under conditions such that a stream of liquid is generated in said first microchannel and said first and second particles are separated in said second microchannel. Again, it is preferred that the stream is generated by conveying said liquid sample by gravity into said first microchannel. Again, in one embodiment, the method further comprises, after step b), detecting said separated particles.

The present invention also contemplates a method of separating particles, comprising: a) providing: i) a device comprising a sample inlet in liquid communication with a first microchannel, said first microchannel in liquid communication with a second microchannel, said second microchannel separated from a third microchannel by a membrane, said membrane having pores; ii) a sample comprising a liquid mixture of first particles and second particles, said first and second particles being of different size; and b) introducing said sample into said device via said sample inlet under conditions such that a stream of liquid is generated in said first microchannel and said first and second particles are separated in said second microchannel. Again, it is preferred that the stream is generated by conveying said liquid sample by gravity into said first microchannel. Again, the method may further comprise, after step b), detecting said separated particles.

It is not intended that the device of the present invention be fabricated with a particular material. However, in a preferred embodiment, the device elements are microfabricated from poly(dimethylsiloxane) (PDMS), a material with several properties that make it attractive for biological applications. PDMS is biocompatible, optically transparent, gas permeable, non-toxic, and easy to mold. These properties are useful for culturing cells and for performing optical microscopy.

While PDMS is preferred, the present invention also contemplates other materials for fabrication. In some embodiments, the devices of the present invention are fabricated from silicon, glass and/or plastic.

It is not intended that the present invention be limited to the type of particles being separated. In one embodiment, cells such as blood cells, bone marrow cells and stem cells are separated. In another embodiment, microorganisms (e.g. bacteria) are separated (e.g. from a heterogeneous mixture). It yet other embodiments, tumor cells are separated (e.g. from non-tumor cells). It still other embodiments, fetal cells are separated (e.g. from maternal cells).

It is also not intended that the invention be limited by the particular purpose for carrying out the separations. In one medical diagnostic application, it may be desirable to differentiate between normal red cells and the red cells characteristic of sickle cell disease. On the other hand, it may be desirable to simply detect the presence or absence of specific pathogens in a clinical sample. For example, different species or subspecies of bacteria may have different susceptibilities to antibiotics; rapid identification of the specific species or subspecies present in the sample aids diagnosis and allows initiation of appropriate treatment.

In some applications, such as diagnosis of sickle cell anemia, the above-described device by itself (i.e. using only sedimentation velocity as a basis for separation) is contemplated to provide sufficient cell sorting resolution to give useful information. On the other hand, certain applications may require additional separating elements. In a preferred embodiment, the microsorter device of the present invention further comprises (i) an adhesive cell-sorting component, and/or (ii) a chemotactic cell-sorting component.

The adhesive cell sorting component of the present invention can be incorporated directly into the device by lengthening the separation channel and twisting the separation channel by up to approximately 90 degrees (and in some cases greater than 90 degrees). This twisted construction takes advantage of the “soft” nature of PDMS channels. While the present invention is not limited to any mechanism by which separation is achieved, it is believed that the incorporation of the twist i) stops microhydrodynamic sorting, ii) translates the differences in the vertical positions of the cells into differences in the z-direction, and iii) promotes interaction of cells with the channel floor (gravity will now cause cells to settle towards the floor of the adhesive sorting component). Cells sorted into different lanes in the z-direction, according to the differences in microhydrodynamic characteristics, will now be separated in the x-direction according to differences in their adhesive characteristics (i.e. some cells may not adhere at all and the non-adhering cells can be collected at the outlet in a cell collection chamber).

It is not intended that the present invention be limited by the manner in which the surface of the adhesive sorting component is treated so as to create an adhesive character. A variety of approaches are contemplated. In one embodiment, the surface of the adhesive sorting component is derivatized by chemical derivatization of the PDMS surface through plasma oxidation and subsequent chemical reactions. In another embodiment, the surface of the adhesive sorting component is modified by physical adsorption or chemical immobilization of proteins (e.g. fibronectin, fibrinogen, antibodies, selecting, cytokines, cytokine receptors, etc.) to the surface. In yet another embodiment, the surface of the adhesive sorting component is modified by growth of a monolayer of endothelial cells in the lumen of the channel followed by activation of cell surface receptors with cytokines or formyl-peptides.

The chemotactic sorting component is an element contemplated to produce a chemical gradient between an upper channel and a lower channel. The upper channel corresponds to the adhesion-based sorting component. The channels are interconnected by small pores, analogous to the configuration of Boyden Chambers, which are widely used for chemotaxis studies. The three-layer device is readily fabricated using multilayer soft lithography or simply by allowing the layers to adhere by conformal contact; a membrane with pores can be sandwiched by two channels on the top and bottom.

It is not intended that the present invention be limited to the use of specific chemotatic agents. A variety of such agents are contemplated. Exemplary chemotactic agents to fill the lower channel and generate a chemical gradient include formyl-peptides (which activate a broad spectrum of immune cells and endothelial cells), and cytokines (a large variety of cytokines are commercially available; these peptides are highly specific in terms of what type of leukocyte or lymphocytes it activates).

As noted above, the present invention contemplates a modular design, whereby the above-described additional sorting elements can be added (e.g. in series). In one embodiment, a microhydrodynamic sorting region (“a first sorting region”) in the separation channel is supplemented by the use of an adhesion sorting element (defining “a second sorting region”) followed by a chemotactic sorting element (defining “a third sorting region”). In operation, mixtures of cells enter via the sample inlet and the cells are initially sorted to different heights in the separation channel according to their differences in microhydrodynamic characteristics. A twist in the channel transforms these height differences into differences in position of the cells in the z-direction. These cells are then further sorted in the x- and y-directions according to their chemotactic characteristics.

Definitions

The following definitions are provided for the terms used herein:

“Biological reactions” means reactions involving biomolecules such as enzymes (e.g., polymerases, nucleases, etc.) and nucleic acids (both RNA and DNA).

The term “sample” encompasses all types of samples, including environmental samples (e.g. earth samples, water samples, waste samples, etc.) and biological samples. “Biological samples” are those containing cells and/or biomolecules, such proteins, lipids, nucleic acids. The sample may be from a microorganism (e.g., bacterial culture) or from an animal, including humans (e.g. blood, urine, etc.). Alternatively, the sample may have been subject to purification (e.g. extraction) or other treatment. The present invention contemplates separation of particles, including cells, from biological samples.

The present invention contemplates separating particles such as cells. In some embodiments, such separating is followed by treatment of cells in chemical or biological reactions. “Chemical reactions” means reactions involving chemical reactants, such as inorganic compounds. “Biological reactions” means reactions involving biomolecules such as enzymes (e.g., polymerases, nucleases, etc.) and nucleic acids (both RNA and DNA).

“Channels” are pathways through a medium that allow for movement of liquids and gasses. Channels thus can connect other components, i.e., keep components “in liquid communication.” “Microchannels” are channels configured (in microns) so as to accommodate small volumes of fluid (including but not limited to “microdroplets”). While it is not intended that the present invention be limited by precise dimensions of the microchannels employed in the separating devices, illustrative ranges for channels are as follows: the channels can be between 0.35 and 50 μm in depth (preferably 20 μm) and between 50 and 1000 μm in width (preferably 500 μm). It is specifically contemplated that the present invention may employ both i) channels of uniform dimensions, and ii) channels of changing dimensions. For example, the present invention contemplates stream-focusing channels which are uniform and stream-focusing channels which are not uniform. With regard to the latter, the beginning of the channel may be wider (e.g. have a greater radius) than the middle or end of the channel. In one embodiment, a “v” design is employed, whereby a stream-focusing channel gradually narrows (e.g. the radius gradually decreases) from the beginning to the end, along the length of the channel. On the other hand, the present invention also contemplates separating channels wherein the channel gradually widens (e.g. the radius of the channel gradually increases) from the beginning of the channel to the end of the channel.

“Conveying” means “causing to be moved through” as in the case where fluid (e.g. whether continuous as in a stream, or discrete as in a microdroplet) is conveyed through a channel to a particular point, such as a separation region. Conveying can be accomplished via flow-directing means. A stream can be “focused” by the process of the liquid (e.g. from a sample or reservoir) being conveyed through a channel of particular dimensions.

“Flow-directing means” is any means by which movement of a fluid (e.g. whether continuous as in a stream, or discrete as in a microdroplet) in a particular direction is achieved. A preferred directing means employed by the present invention (and, in some embodiments, integrated into the separating device) is a gravity pump. In other embodiments, other pumps are used. For example, pumps have also been described, using external forces to create flow, based on micromachining of silicon. See H. T. G. Van Lintel et al., Sensors and Actuators 15:153-167 (1988).

A “cell barrier” is any structure or treatment process on existing structures that prevents the movement of cells through the structure. The present invention contemplates the use of such cell barriers so as to direct cell flow. In some embodiments, the cell barriers of the present invention are membranes having pores, said pores dimensioned so as to permit the flow of liquid and biomolecules. In particular embodiments, the pores permit certain cells to pass but prevent other cells from moving through the pores.

“Liquid barrier” or “moisture barrier” is any structure or treatment process on existing structures that prevents the movement of fluid through the structure (e.g. whether continuous as in a stream, or discrete as in a microdroplet).

A “mixture of particles in a liquid” describes undissolved material in the particular liquid. For example, bubbles of gas, oil, or other substances may remain undissolved in certain liquids (e.g. aqueous solutions) and are therefore “particles” for purposes of the present invention. Similarly, cells are not soluble in cell culture media and are therefore “particles” for purposes of the present invention. Particles may be biological (e.g. cells) or may be synthetic; the latter being made of a variety of substances (including but not limited to polymers).

### DESCRIPTION OF THE DRAWINGS

FIG. 1 is a schematic representing an embodiment of the separating device of the present invention which utilizes only microhydrodynamic-based sorting. The dotted circle is shown enlarged and modified in FIG. 7.

FIG. 2 is a schematic representing an embodiment of the separating device of the present invention which utilizes microhydrodynamic-based sorting together with adhesive sorting.

FIG. 3 is a schematic showing a three layer, two channel embodiment of the present invention.

FIG. 4 is a schematic representing an embodiment of the separating device of the present invention which utilizes microhydrodynamic-based sorting, along with adhesive sorting and chemotactic sorting.

FIG. 5 schematically shows one embodiment of a method for fabricating a stacked two channel design.

FIG. 6 is a schematic diagram of cell movement in the widening separation channel.

FIG. 7 represents an enlarged and modified region defined by the dotted circle shown in FIG. 1. FIG. 7A is a schematic diagram of one embodiment of a separating channel for improved 2-D focusing. FIG. 7B is a schematic diagram of one embodiment of a separating channel for improved 3-D focusing.

FIG. 8 is a schematic representation of an embodiment of a gravity-driven pump used in a separating device.

FIG. 9 schematically shows one approach for observing the trajectories of different size particles (thereby detecting separation).

FIG. 10 shows images of different size particles being separated in a device of the present invention.

FIG. 11 schematically shows one embodiment of a sample inlet or reservoir designed to minimize clogging.

FIG. 12A schematically shows another embodiment of a separation channel wherein a wall of the channel has a wave (sinusoidal) pattern and the wave length is of uniform length (λ₁=λ₂). FIG. 12B schematically shows an embodiment of a separation channel wherein a wall of the channel has a wave pattern and the wave length is not uniform over the length of the channel (λ₁>λ₂).

FIG. 13 schematically shows another embodiment of a separation channel wherein the widening of the channel, defined by the angle (a, b, c, etc.), increases.

### DESCRIPTION OF THE INVENTION

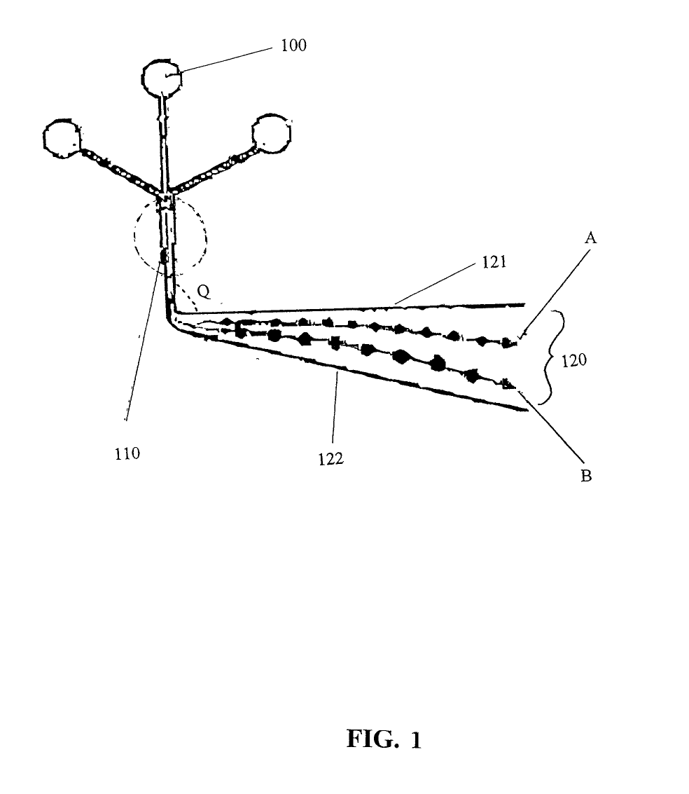

The present invention relates to microscale separating devices, methods for fabricating separating devices, and methods for separating particles in microscale devices. FIG. 1 shows one embodiment of the device, an sample inlet port (100) or sample reservoir (100) is linked to a vertically positioned (y axis) stream-focusing channel (110), said channel linked to a horizontally positioned (x axis) separating channel (120), said separating channel having an upper wall (121) and a lower wall (122), said lower wall (122) angled in relation to said upper wall such that said separating channel widens along the length of the channel.

Importantly, it is not intended that the present invention be limited to positioning the stream-focusing channel at a 90 degree angle in relationship to the separating channel. When gravity-driven separation is used, the two channels can be in a relationship such that the angle (indicated by “Q” in FIG. 1) is between approximately 170 degrees and approximately 45 degrees, and more preferrably between approximately 120 degrees and approximately 80 degrees. Moreover, the two channels need not be in a perfect x-axis/y-axis alignment. When gravity-driven separation is not used (e.g. other forces are employed such as electric fields, magnetic fields, etc.), the two channels can even be in the same plane (e.g. 180 degrees) and configured in a straight line. Indeed, in such cases, a single channel (rather than two channels) can be used, wherein a first portion of the channel causes the stream of liquid to focus and a second portion of the channel widens, resulting in separation.

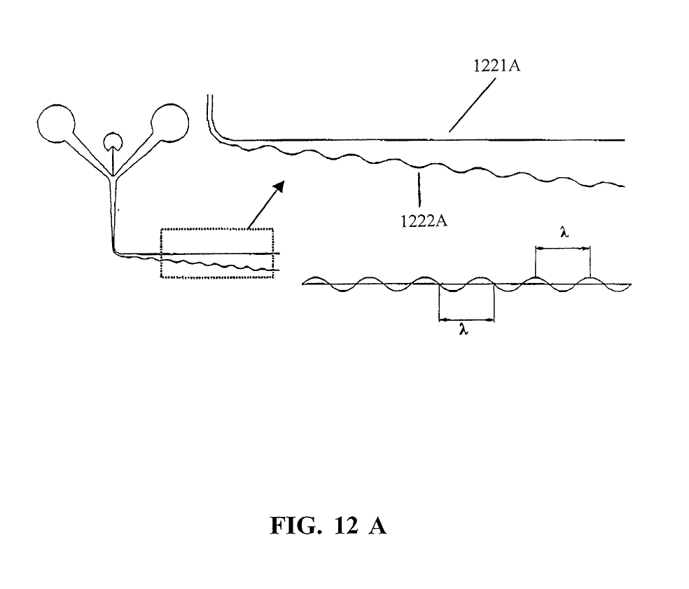

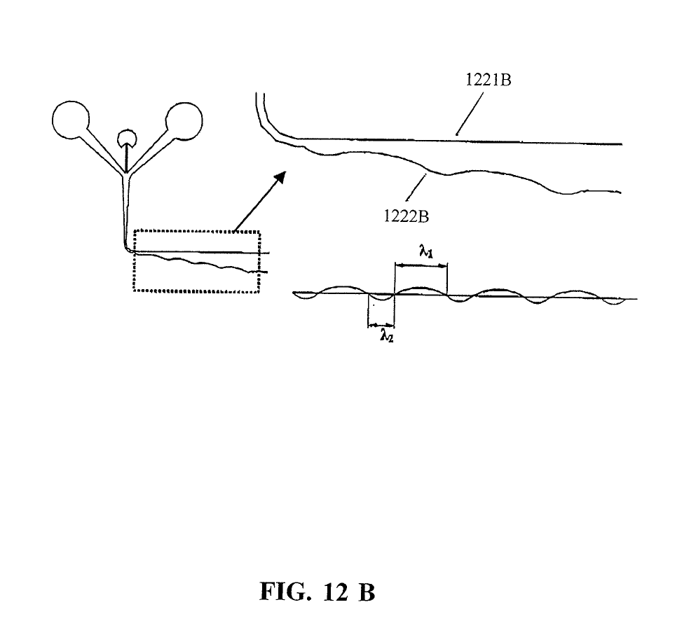

While FIG. 1 shows smooth channel walls, the present invention is not limited to linear or smooth channel walls. FIG. 12A schematically shows another embodiment of a separation channel having a upper (1221A) and lower wall (1222A), wherein the lower wall (1222A) of the channel has a wave (sinusoidal) pattern and the wave length is of uniform length (λ₁=λ₂). FIG. 12B schematically shows an embodiment of a separation channel having an upper (1221B) and lower wall (1222B), wherein the lower wall (122B) of the channel has a wave pattern and the wave length is not uniform over the length of the channel (λ₁>λ₂). Of course, the application of the wave pattern is not confined only to the corrugation of the lower wall, but is also applicable to other walls of the separation device of the present invention.

In operation, a liquid cell mixture is introduced into the device via the sample inlet port (100) such that a stream of liquid is created in said stream-focusing channel (110), said stream thereafter entering the horizontally positioned separating channel (120). As the cells enter the horizontally positioned separating channel (120), the trajectories of the cells in the stream will start to deviate from the line of flow (due to gravitational accelerations) in a direction perpendicular to the direction of flow. “Small” cells (FIG. 1, line A) will closely follow the line of flow whereas “large” cells (FIG. 1, line B) will have a tendency to move towards the direction of gravitational acceleration. As the separating channel (120) widens, the flow stream also widens, resulting in rapid sorting within short channel lengths (“separation amplification”).

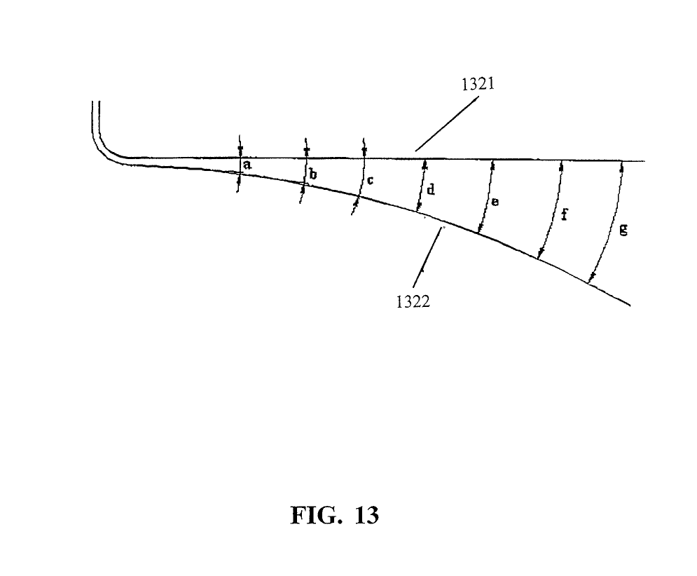

It is not intended that the present invention be limited to separation channels which widens out at a constand angle. FIG. 13 schematically shows another embodiment of a separation channel having an upper wall (1321) and a lower wall (1322), wherein the widening of the channel, defined by the angle (a, b, c, etc.), increases gradually in a stepwise manner. Compared to a channel that widens out at a constant angle, this design is contemplated to provide migrating cells with an additional velocity component in the cross-stream direction due to the change of the widening-out angle as the cells flow along downstream, resulting in further “separation amplification” between large and small cells.

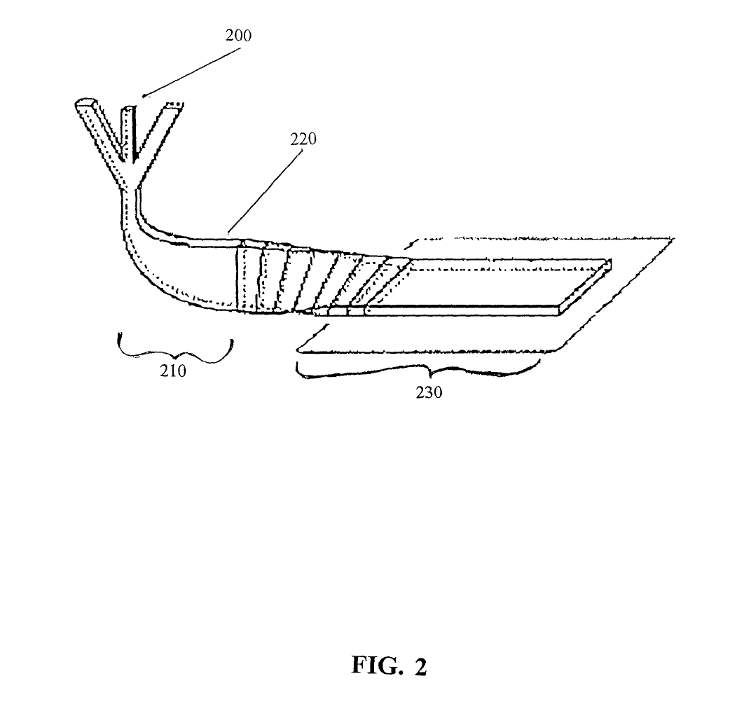

FIG. 2 illustrates how the adhesive cell sorting component of the present invention can be incorporated directly into the device by lengthening the separation channel (220) and twisting the separation channel approximately 90 degrees to create a region (230) of adhesive sorting. In operation, a liquid mixture of cells is introduced via the sample inlet port (200) and the cells are initially sorted by sedimentation in first sorting region (210). Thereafter, the cells are sorted in the region (230) of adhesive sorting.

A device employing the adhesive sorting component shown in FIG. 2 can sort cells using a mechanism that is similar to the way in which the human body recruits specific types of cells to specific regions. The human body recruits particular subsets of immune cells to sites of injury by producing molecular signals on the inside wall of blood vessels (this inside wall is called an endothelium). The specific combination of molecular signals specifies the type of immune cells (or leukemic and metastatic tumor cells in the case of some diseases) recruited. In the present invention, these specific molecular signals can also be employed by attaching such molecules (e.g. cytokines, etc.) to the adhesive sorting component to create an “artificial endothelium.” Multiple outlet ports can be added at the end of the artificial endothelium to collect and sample cells that do not attach to the surface of the adhesive sorting surface. However, in some embodiments, it is sufficient simply to detect separation of cells (e.g. microscopically, by light scattering, using biomarkers, etc.).

Importantly, cell attachment inside microfluidic channels requires low shear. Because the device of the present invention has a widening-out design, the flow velocity is fastest at the inlets and becomes slower as the flow proceeds. This results in selective attachment of cells in the downstream region. This has been experimentally confirmed with various channel geometries using bovine capillary endothelial cells. An analogous phenomena is known to occur within the human body; enhanced attachment of leukocytes occurs in regions of our vascular system where capillary blood vessels widen out.

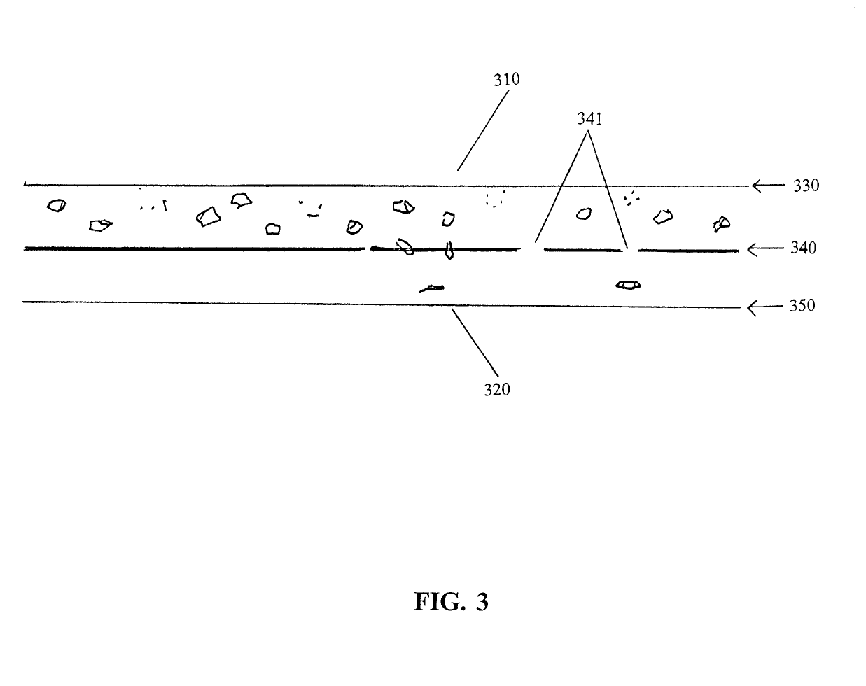

FIG. 3 illustrates one embodiment of one portion of a sorting device of the present invention which employs a chemotactic sorting component. The portion shown in FIG. 3 comprises an upper channel (310) and a lower channel (320) created by a first layer (330), second layer (340) and a third layer (350). There is a chemical gradient between the upper channel (310) and the lower channel (320). In one embodiment, the upper channel (310) corresponds to the adhesion-based sorting component. The channels are interconnected via the second layer (340), said second layer having small pores (341). The size of the pores can be such that at least some cells are permitted to pass between the chambers. The membrane with pores shown in FIG. 3 can also function as an “artificial endothelium” in that it can utilize soluble (not membrane bound) molecular signals that the natural endothelium uses to sort blood cells, leukemic cells, and metastatic tumor cells into 3-dimensional (3-D) space.

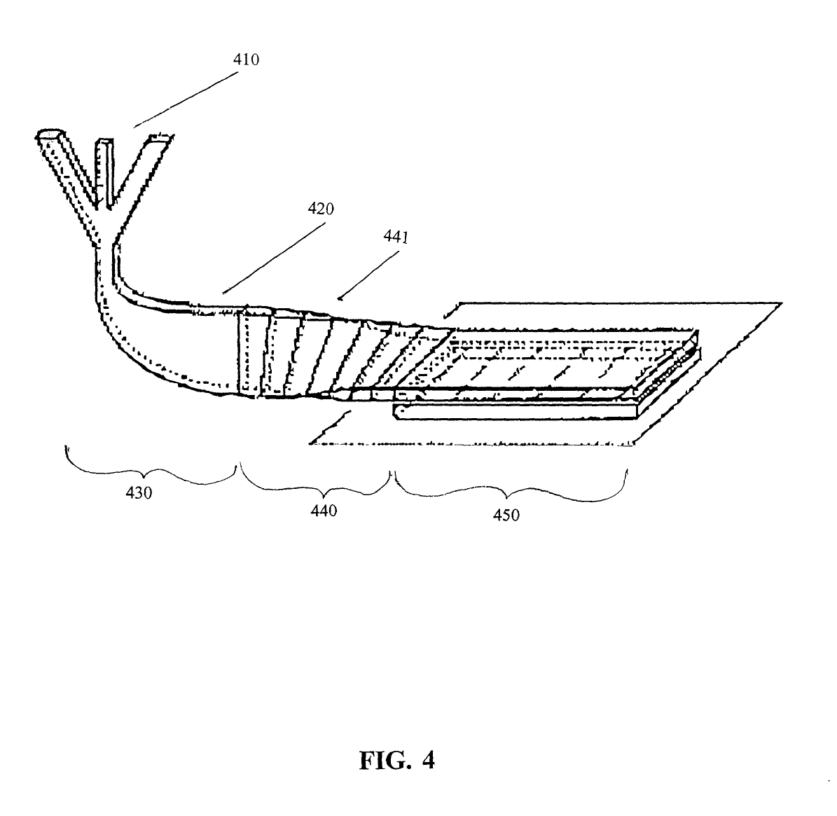

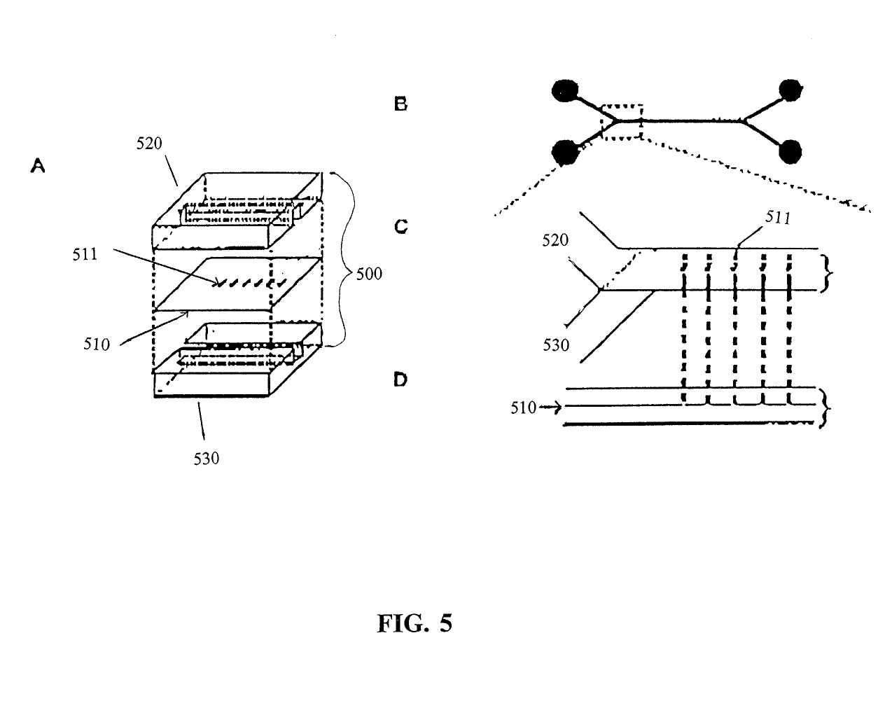

FIG. 4 illustrates the modular design of the devices of the present invention; additional sorting elements can be added (e.g. in series). In the embodiment shown in FIG. 4, a first sorting region (430) in the separation channel is supplemented by the use of an a second sorting region (440) based on adhesion sorting, followed by a third sorting region (450) based on chemotactic sorting. In operation, mixtures of cells enter via the sample inlet (410) and the cells are initially sorted to different heights in the separation channel (420) according to their differences in microhydrodynamic characteristics. A twist (441) in the channel transforms these height differences into differences in position of the cells in the z-direction. These cells are then further sorted in the x- and y-directions according to their chemotactic characteristics.

I. Design of Microsorting Devices

A. PDMS Fabrication

Although there are many formats, materials, and size scales for constructing integrated fluidic systems, the present invention contemplates that, in preferred embodiments, the microsorting device of the present invention (including the microfluidic channels) are to be made of PDMS, fabricated using a technique called “soft lithography”. PDMS is an attractive material for six reasons: (i) low cost; (ii) optical transparency; (iii) ease of molding; (iv) elastomeric character; (v) surface chemistry of oxidized PDMS can be controlled using conventional siloxane chemistry; (vi) compatible with cell culture (non-toxic, gas permeable). Soft lithographic rapid prototyping is employed to fabricate the desired microfluidic channel systems. The key features of this method are to make the master required to form the microchannel system using a pattern printed onto a transparency film using a conmercial high-resolution printer. This method has the virtue that the entire process—from concept to prototype device—can be as quick as 24 hours, and is inexpensive.

More specifically, soft lithography is an alternative to silicon-based micromachining that uses replica molding of nontraditional elastomeric materials to fabricate microfluidic channels. The softness of the materials used allows the device areas to be reduced by more than two orders of magnitude compared with silicon-based devices.

Typically, an elastomer is patterned by curing on a micromachined mold. Molds can be patterned by using a high-resolution transparency film as a contact mask for a thick photoresist layer. However, multilayer soft lithography improves on this approach by combining solft lithography with the capability to bond multiple patterned layers of elastomer. Basically, after separate curing of the layers, an upper layer is removed from its mold and placed on top of the lower layer, where it forms a hermetic seal. Further curing causes the two layers to irreversibly bond. This process creates a monolithic three-dimensionally patterned structure composed entirely of elastomer. Additional layers are added by simply repeating the process. The ease of producing multilayers makes it possible to have multiple layers of fluidics, a difficult task with conventional micromachining.

The present invention contemplates multilayer devices in PDMS. In one embodiment, a network of microfluidic channels (with width approximately 20 micrometers or greater) is designed in a CAD program. This design is converted into a transparency by a high-resolution printer; this transparency is used as a mask in photolithography to create a master in positive relief photoresist. PDMS case against the master yields a polymeric replica containing a network of channels. The surface of this replica, and that of a flat slab of PDMS, are oxidized in an oxygen plasma. These oxidized surfaces seal tightly and irreversibly when brought into conformal contact. Oxidized PDMS also seals irreversibly to other materials used in microfluidic systems, such as glass, silicon, silicon oxide, and oxidized polystyrene. Oxidation of the PDMS has the additional advantage that it yields channels whose walls are negatively charged when in contact with neutral and basic aqueous solutions; these channels support electroosmotic pumping and can be filled easily with liquids with high surface energies (especially water).

In one embodiment, the present invention contemplates a multilayer device wherein two channels are stacked but are in liquid communication via pores. The three-layer device is fabricated using multilayer soft lithography or simply by allowing the layers to adhere by conformal contact. FIG. 5A shows one embodiment of a method for fabricating an embodiment of a device (500) comprising a membrane (510) with pores (511), said membrane positioned between (or “sandwiched by”) two channels on the top (520) and bottom (530). FIG. 5B is a top view of the capillary system after sealing the three layers together. FIG. 5C is a magnified top view of the region inside the dotted square of FIG. 5B. FIG. 5D is a magnified side view of the region inside the dotted square of FIG. 5B.

Chemotactic agents can be used to fill the lower channel (530) and generate a chemical gradient. A variety of chemotactic agents are contemplated including but not limited to formyl-peptides (which activate a broad spectrum of immune cells and endothelial cells), and cytokines (a large variety of cytokines are commercially available; these peptides are highly specific in terms of what type of leukocyte or lymphocytes it activates).

B. Silicon Fabrication

In other embodiments, the present invention contemplates fabricating separating devices out of glass or silicon. Silicon has well-known fabrication characteristics and associated photographic reproduction techniques. The principal modern method for fabricating semiconductor integrated circuits is the so-called planar process. The planar process relies on the unique characteristics of silicon and comprises a sequence of manufacturing steps involving deposition, oxidation, photolithography, diffusion and/or ion implantation, and metallization, to fabricate a “layered” integrated circuit device in a silicon substrate. See e.g., W. Miller, U.S. Pat. No. 5,091,328, hereby incorporated by reference.

For example, oxidation of a crystalline silicon substrate results in the formation of a layer of silicon dioxide on the substrate surface. Photolithography can then be used to selectively pattern and etch the silicon dioxide layer to expose a portion of the underlying substrate. Of course, the particular fabrication process and sequence used will depend on the desired characteristics of the device. Today, one can choose from among a wide variety of devices and circuits to implement a desired digital or analog logic feature.

In a preferred embodiment, channels are prepared on 500 μm thick glass wafers (Dow Corning 7740) using standard aqueous-based etch procedures. The initial glass surface is cleaned and receives two layers of electron beam evaporated metal (20 nm chromium followed by 50 nm gold). Photoresist Microposit 1813 (Shipley Co.) is applied 4000 rpm, 30 seconds, patterned using glass mask 1 and developed. The metal layers are etched in chromium etchant (Cr-14, Cyantek Inc.) and gold etchant (Gold Etchant TFA, Transene Co.) until the pattern is clearly visible on the glass surface. The accessible glass is then etched in a solution of hydrofluoric acid and water (1:1, v/v). Etch rates are estimated using test wafers, with the final etch typically giving channel depths of approximately 20 to 30 μm. For each wafer, the depth of the finished channel can be determined using a surface profilometer. The final stripping (PRS-2000, J. T. Baker) removes both the remaining photoresist material and the overlying metal.

In some embodiments of the device design, single layers of silicon. However, in other embodiments, a triple layer of oxides is employed.

C. Channel Design

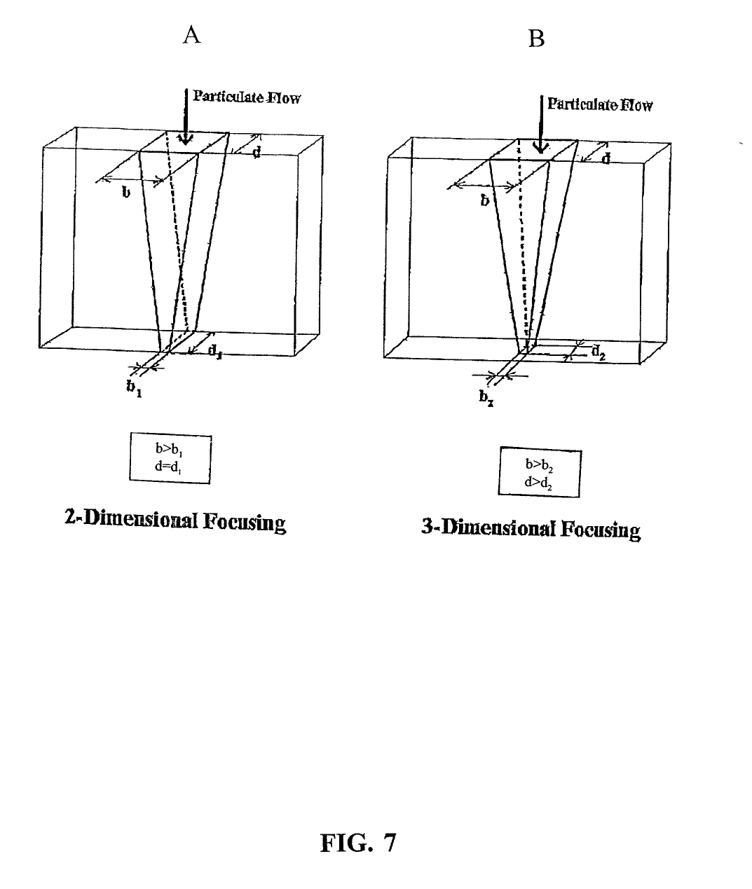

As noted above, it is specifically contemplated that the present invention may employ channels of changing dimensions. For example, the present invention contemplates stream-focusing channels wherein the beginning of the channel may be wider (e.g. have a greater radius) than the middle or end of the channel. In one embodiment, a “v” design is employed, whereby a stream-focusing channel gradually narrows (e.g. the radius gradually decreases) from the beginning to the end, along the length of the channel. FIG. 7B is a schematic diagram of one embodiment of a separating channel for improved 3-D focusing. Using laminar flow etching, the side inlets are larger than the middle inlet, thereby achieving better 3-D focusing.

D. Gravity Pumps

Although a number of approaches can be used to convey the liquid mixture of particles along the channels of the devices of the present invention (such as syringe pumps, peristaltic pumps, electrokinetic pumps, bubble pumps, and air pressure driven pumps), conventional approaches all have inconveniences and incompatibilities in terms of size, power requirements, pulsatile flow, and ability to integrate with the sample inlets. To overcome these limitations, the present invention contemplates a gravity-driven pump that will provide a steady flow rate over long periods of time.

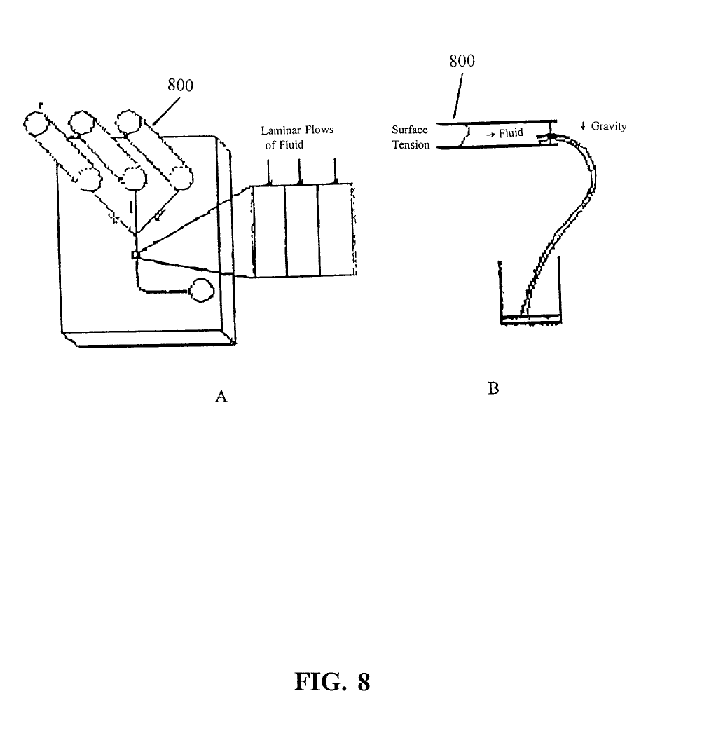

In one embodiment (FIG. 8), the gravity-driven pump comprises a tube (800), with an appropriate diameter, placed horizontally (i.e. in the y-plane) and connected to a thin capillary (810). This configuration eliminates a major problem associated with gravity-driven flow—the drop in flow rate that accompanies decreases in the level of fluid in a reservoir. The law of energy conservation dictates that work performed will be equal to potential energy used (1/2mv²+work performed to overcome capillary force and channel resistance=mgh). Thus, in conventional systems where the height, h, of the fluid in a reservoir decreases as the fluid flows out, the flow velocity, v, will decrease with time.

In one embodiment of the gravity-driven pump of the present invention, the height of the liquid does not change as the amount of liquid decreases because the reservoir is positioned horizontally. By using a tube (800) with the appropriate diameter (e.g. approximately 3 mm for aqueous protein solutions), the liquid is kept by surface tension from spilling out of the reservoir. The only parameter that changes, as the amount of fluid decreases, is the flow resistance in the reservoir resulting from a decrease in length of the tube the fluid occupies. This change in flow resistance, however, is negligible because the diameter of the tube used for the fluid reservoir is much larger than the size of the inlet capillary. Thus the pump provides steady flow-rates regardless of the amount of fluid contained in the reservoirs. Flow resistance is given by

$$R = \frac{8 µL}{π {r}^{4}}$$

for cylindrical pipe and

$$\frac{12 µL}{w} {h}^{3}$$

for rectangular channels. With a typical tube radius and inlet capillary size (e.g. approximately 3 mm-diameter-cylinder that is approximately 1 cm-long vs 0.1×0.5 mm-rectangular inlet channel that is 1 cm-long) the change in flow resistance due to decrease in amount of fluid in the reservoir is less than 0.01%.

Importantly, the pump of the present invention is small, requires no external power, and is simple to construct. In operation, it has been confirmed that steady flow rates are maintained until the fluid level decreases to a point where the meniscus of the liquid in the reservoir approaches the end of the reservoir tube.

E. Ligands For Adhesive Sorting

As noted above, the present invention contemplates separating cells according to differences in their adhesive characteristics (i.e. some cells may not adhere at all and the non-adhering cells can be collected at the outlet in a cell collection chamber). It is not intended that the present invention be limited by the manner in which the surface of the adhesive sorting component is treated so as to create an adhesive character. A variety of approaches are contemplated. In one embodiment, the surface of the adhesive sorting component is modified (e.g. precoated) with a first capture reagent. It is not intended that the present invention be limited by the nature of the capture reagent. In one embodiment, the capture reagent is a cytokine or cytokine binding ligand (such as a capture antibody specific for the cytokine to be detected). In other embodiments, second capture reagents are used (either in the same region or in a distinct and separate region) for separation of more subpopulations of cells.

In a preferred method, freshly isolated, primary cell populations (e.g., lymph node, spleen cells, etc.) are subsequently introduced into the device so as to come in contact with the capture reagents. The bound, captured cell can be visualized microscopically with or without a detection reagent. It is not intended that the present invention be limited by the nature of the detection reagent. In one embodiment, the detection reagent is a second cytokine binding ligand (e.g., antibody) free in solution that is conjugated to enzyme. The addition of substrate results in an enzymatic color reaction.

It is not intended that the present invention be limited by the nature of the cytokine to be detected. Cytokines are hormone-like substances secreted by a wide variety of cells, including (but not limited to) lymphocytes (e.g., T cells), macrophages, fibroblasts, and endothelial cells. It is now known that cytokines consist of a broad class of glycoproteins that have the ability to regulate intercellular communication (e.g., cell-cell interaction) in both normal and pathologic situations. Cytokines generally contain from approximately 60 to 200 amino acid residues, with a relative molecular weight of between 15 and 25 kd. At least 35 distinct cytokines have been elucidated (see Table below).

TABLE 1

| Name | Abbr. | Type | Specific Name |
|---|---|---|---|
| Interferons | IFN | alpha | Leukocyte Interferon |
| | | beta | Fibroblast Interferon |
| | | gamma | Macrophage Activation Factor |
| Interleukins | IL-1 | 1 alpha | Endogenous Pyrogen |
| | | 1 beta | Lymphocyte-Activating Factor |
| | | 1 ra | IL-1 Receptor Antagonist |
| | IL-2 | | T-cell Growth Factor |
| | IL-3 | | Mast Cell Growth Factor |
| | IL-4 | | B-cell Growth Factor |
| | IL-5 | | Eosinophil Differentiation Factor |
| | IL-6 | | Hybridoma Growth Factor |
| | IL-7 | | Lymphopoietin |
| | IL-8 | | Granulocyte Chemotactic |
| | | | Protein |
| | IL-9 | | Megakaryoblast Growth Factor |
| | IL-10 | | Cytokine Synthesis Inhibitor |
| | | | Factor |
| | IL-11 | | Stromal Cell-Derived Cytokine |
| | IL-12 | | Natural Killer Cell Stimulatory |
| | | | Factor |
| Tumor Necrosis | TNF | alpha | Cachectin |
| Factors | | beta | Lymphotoxin |
| Colony Stimulating | CSF | GM-CS | Granulocyte-macrophage Colony |
| Factors | | F | Stimulating Factor |
| | | Mp-CS | Macrophage Growth Factor |
| | | F | |
| | | G-CSF | Granulocyte Colony-stimulating |
| | | | Factor |
| | | EPO | Erythropoietin |
| Transforming | TGF | beta 1 | Cartilage-inducing Factor |
| Growth | | beta 2 | Epstein-Barr Virus-inducing |
| Factor | | | Factor |
| | | beta 3 | Tissue-derived Growth Factor |
| Other Growth | LIF | | Leukemia Inhibitory Factor |
| Factors | MIF | | Macrophage Migration- |
| | | | inhibiting Factor |
| | MCP | | Monocyte Chemoattractant |
| | | | Protein |
| | EGF | | Epidermal Growth Factor |
| | PDGF | | Platelet-derived Growth Factor |
| | FGF | alpha | Acidic Fibroblast Growth Factor |
| | | beta | Basic Fibroblast Growth Factor |
| | ILGF | | Insulin-like Growth Factor |
| | NGF | | Nerve Growth Factor |
| | BCGF | | B-cell growth factor |

There is also a family of chemoattractant cytokines known as “chemokines.”See e.g. T. J. Schall and K. B. Bacon, “Chemokines, leukocyte trafficking, and inflammation” Curr. Op. Immun. 6:865-873 (1994). These molecules share structural similarities, including four conserved cysteine residues which form disulfide bonds in the tertiary structures of the proteins. The present invention contemplates employing chemokines in the context of the devices and methods of the present invention (e.g. using secreted chemokines in the membrane/pore embodiment discussed above).

The present invention also contemplates using cytokine receptors in the adhesive sorting process. The existence of IL-1 plasma membrane receptors which bind both IL-1α and IL-1B is now well-established. IL-1 receptors have now been cloned and expressed in high yield. See S. K. Dower, U.S. Pat. No. 4,968,607, hereby incorporated by reference. Similarly, tumor necrosis factor-α and B receptors have been isolated and DNA sequences encoding these secretory proteins are described. See C. A. Smith et al., European Patent Application No. 90309875.4 (Publication No. 0418014A1), hereby incorporated by reference. See also U.S. patent application Ser. Nos. 405,370, 421,417 and 523,635, hereby incorporated by reference.

II. Operational Theory of Microsorting Devices

It is not necessary that one understand any theory or mechanism in order to practice the various embodiments of the present invention. Moreover, the present invention is not limited to any theory or mechanism by which the devices and methods of the present invention operate successfully. Nonetheless, it is believed that there are at least three important features in the design of the devices of the present invention that contribute to operational success: (i) laminar flow, (ii) sedimentation velocity, and (iii) amplification of separation using a widening channel. Flows in microfluidic channels have low Re numbers due to the small channel dimensions, and are laminar; the streamlines are orderly. Low Re flows allow use of hydrodynamic focusing to produce a tightly focused stream of cells from the middle inlet as the cells flow down the vertical channel (FIG. 1, element 110). As these cells enter the horizontally oriented channel (120), the trajectories of the cells in this tightly focused stream will start to deviate from the flow streamline due to gravitational accelerations in a direction perpendicular to the direction of flow. Gravity will cause sedimentation of cells at a velocity (v), which is given by

$$v = \frac{2 {r}^{2} g Δρ}{9 µ} ,$$

where Δp is the density difference between carrier fluid and cells, r is the radius of spherical cells or the effective radius of non-spherical cells, μ is the viscosity of the carrier fluid and g is acceleration due to gravity. As seen from this equation, differences in sedimentation velocity arise from differences in effective size. “Small” cells will closely follow the line of flow whereas “large” cells will have a tendency to cross streamlines towards the direction of gravitational acceleration.

To sort cells more efficiently than is possible by the simple use of differences in sedimentation velocity, the present invention incorporates a new concept. In one embodiment of the device of the present invention, the horizontally oriented spearation channel widens out with distance (e.g. widen from approximately 100-300 μm to approximately 1-6 mm over a distance of approximately 1-3 cm). As the channel widens, the flow streamlines also widen. The separation between cells in different streamlines is “amplified,” resulting in rapid sorting within short channel lengths that are small enough to fit on a chip.

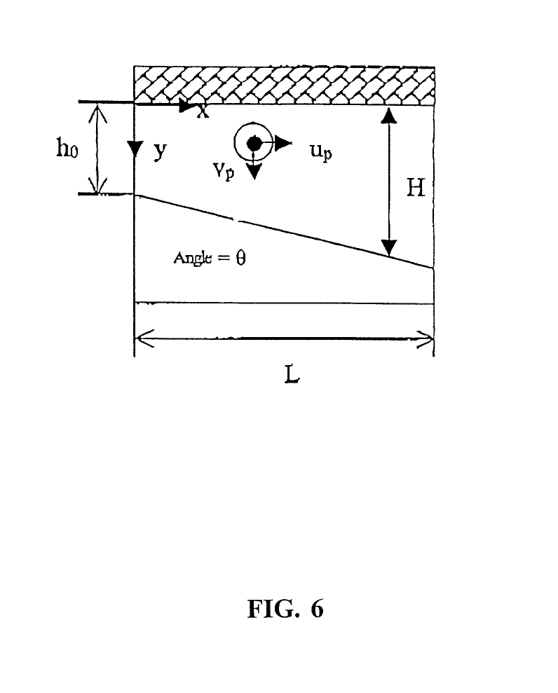

FIG. 6 shows a schematic diagram of particle movement along the widening channel. The particle is moving at velocity uₚ in the x-direction and vₚ in the y-direction along a microchannel with an initial height of hₒ, final height of H, length L, and widening angle θ. From the force balance in the x- and y-directions, we obtain uₚ=u_{f} and

$${υ}_{p} = {υ}_{f} + \frac{2 {r}^{2} g Δρ}{9 µ} .$$

Here, υ_{f} represents the y-direction velocity induced by widening of the channel.

The governing equations and boundary conditions for u_{ƒ} and υ_{f} are given by,

$$\frac{{\partial }^{2} {u}_{f}}{\partial {y}^{2}} + \frac{{\partial }^{2} {u}_{f}}{\partial {z}^{2}} = \frac{1}{μ} \frac{\partial p}{\partial x}$$

$$\frac{\partial {u}_{f}}{\partial x} + \frac{\partial {υ}_{f}}{\partial y} = 0$$

$$\underline{u} ( x , y = 0 , z ) = \underline{u} ( x , y = H , z ) = 0$$

$$\underline{u} ( x , y , z = \pm d / 2 ) = 0$$

where H=h₀+x tan θ, u=u_{ƒ}êₓ+υ_{ƒ}ê_{y} and d represents thickness of the channel. Once again, detailed theoretical analysis of the separation amplification effect is not necessary in order for one to successfully take advantage of the effect in the devices of the present invention.

### Experimental

The following examples serve to illustrate certain preferred embodiments and aspects of the present invention and are not to be construed as limiting the scope thereof.

In the experimental disclosure which follows, the following abbreviations apply: eq (equivalents); M (Molar); μM (micromolar); N (Normal); mol (moles); mmol (millimoles); μmol (micromoles); nmol (nanomoles); gm (grams); mg (milligrams); μg (micrograms); L (liters); ml (milliliters); μl (microliters); cm (centimeters); mm (millimeters); μm (micrometers); nm (nanometers); ° C. (degrees Centigrade).

It is not intended that the present invention be limited to the situation where a mixture is completely separated into homogeneous subunits. First, it is suffiecient if only a portion (10%, more preferably greater than 10%, still more preferably greater than 20%) is separated. Second, the portion that is separated need only be partially separated (the subunit that is separated can still be contaminated by members of another subunit). It is sufficient, that within a subunit, there be greater than 60% representation of the subunit (permitting up to 40% contamination of members of other subunits). Finally, the invention is not limited to how much spatial seperation is acheived. In this regard, subunits within a mixture can be simply seperated into streams that are adjacent to each other or into regions that may or may not be adjacent to each other.

### EXAMPLE 1

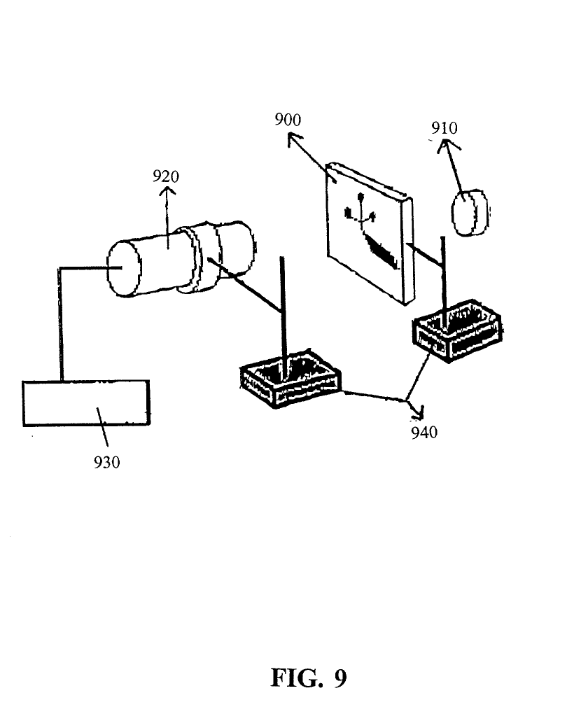

In this example, cell separation was detected. The approach is shown schematically in FIG. 9. Briefly, a video microscope (920) was set up sideways to view the trajectories of different size polystyrene beads traveling through the channels of the device shown in FIG. 1 (900). The microscope (920) was positioned so as to reveal the flow of particles just as they enter the horizontally oriented, widening part of the separating channel (see FIG. 1). A light source (910) was position behind the device (900). Images of different size polystyrene beads were captured using a computer (930); alternatively, a camera (e.g. video camera) can be used.

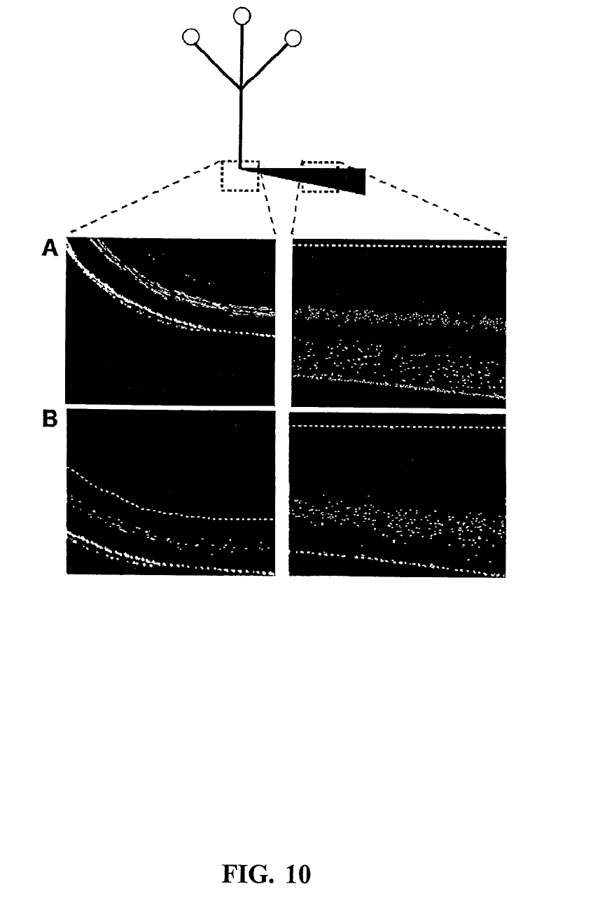

To run the experiment, white 20 μm, red 3 μm, and blue 1 μm polysturene particles were employed. FIG. 10 shows the results (the straight dotted lines depict the walls of the channels). FIG. 10A shows the results for separating 1 and 20 μm particles. The left-hand panel is an image depicting the flow of the mixture just as the particles enter the widening portion of the separating channel. The right-hand panel is an image depicting the separation of particles after traveling 2 cm in the separation channel. Note that the different size particles are totally separated with the smaller (1 μm) particles in the middle and the larger (20 μm) particles towards the bottom of the channel.

FIG. 10B shows the results for separating 3 and 20 μm particles. The left-hand panel is an image depicting the flow of the mixture just as the particles enter the widening portion of the separating channel. The right-hand panel is an image depicting the separation of particles after traveling 2 cm in the separation channel. Note that the different size particles are totally separated with the smaller (3 μm) particles in the middle and the larger (20 μm) particles towards the bottom of the channel.

The results shown in FIGS. 10A and 10B demonstrate the feasibility of separating particles according to the methods and devices of the present invention. Importantly, the resolution of the inexpensive video microscope used for detecting cells is sufficient and allowed imaging of the spatial sorting of 1, 3 and 20 μm polystyrene particles.

### EXAMPLE 2

This example investigates the adhesive binding of cells. More specifically, bacteria are separated using patterned surface adhesiveness. First, solutions of bovine serum albumin co-labeled with mannose and fluorescein are allowed to flow into a designated portion of a channel; the solution is conveniently incubated for approximately 15-60 minutes. Following washing with PBS, a liquid mixture of bacteria is introduced into the channels. E. coli RB 128 are used since this uropathogenic strain of bacteria binds to mannose. Non-adherent cells are removed by washing with PBS.

### EXAMPLE 3

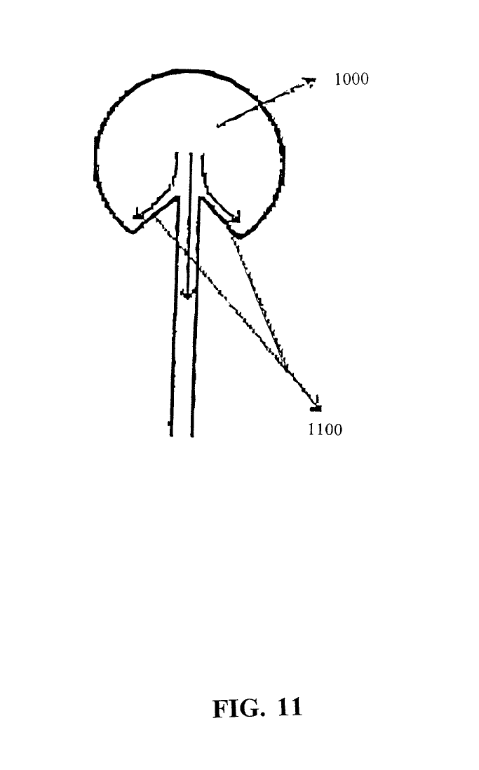

During the course of studies involving the flowing of cells and particles into microfluidic channels, it was discovered that the inlet channels could become clogged by particles at the entrance. To minimize clogging problems, anti-clog edges have been incorporated. More specifically, FIG. 11 schematically shows one embodiment of a sample inlet or reservoir (1000) designed to minimize clogging through the use of slanting edges (1100).

### EXAMPLE 4

A PDMS slab was etched using solft lithography to create channels of approximately 100 μm. The slab was attached to a slide glass to obtain a sealed fluidic module. In order to align the sorter parallel to the gravitational direction, the channel was placed on an XYZ vertical stage (Newport, Irvine, Calif.) and a stereoscope (Nikon, SMZ-1500) was held sideways by a boom stand to observe sample separation in the channels. Again, different sized and colored polystyrene microbeads were used. Three different sorting channels were examined: 1) a channel with a 0.5 mm width at the entrance which widens to 2.5 mm far downstream; 2) a narrow parallel-walled channel (i.e. uniformly narrow with a width of 0.5 mm); and 3) a wide parallel-walled channel (i.e. uniformly wide with a width of 2.5 mm). Separation of the beads was shown to be superior in the first channel type (i.e. widening channel).

### EXAMPLE 5

Separation of aggregated and non-aggregated rabbit red blood cells was demonstrated. Lectin-mediated agglutination forms large aggregates of red blood cells. When mixed with non-aggregated ones, a heterogeneous population (in terms of size) is created. Using the widening channel embodiment, it was found that large cell clumps were well-separated from smaller ones.

Of course, human blood cells can also be separated. Indeed, it is contemplated that such separation can be used to detect viral or bacterial infection of blood cells.

### EXAMPLE 6

The sorting of different sized perfluorocarbon (PFC) droplets used in medical ultrasound was performed. Droplet emulsions prepared by sonication or high-speed shaking are polydisperse and it is necessary to remove large droplets which are not transpulmonary and therefore potentially harmful due to undesired blockage of blood flow and tissue damage. When using the widening channel embodiment, it was found that large droplets migrated downward and were sorted from the stream of smaller droplets.

### EXAMPLE 7

The present invention contemplates using the sorting embodiments described above to enrich for stem cells. For example, adult mouse neural stem cells are sorted by size (larger than 12 microns) and by lack of binding to peanut agglutinin and anti-HSA antibody (reference Nature 2001, 412, 736). The sorting embodiment can be coupled with microfluidic channels coated with peanut agglutinin and anti-HAS antibody to produce a microfluidic neural stem cell sorter. In this setup, the channels would be used to sort cells that are larger than 12 microns. These larger cells would be directed into a second channel whose walls are coated with peanut agglutinin and anti-HAS antibody. Cells expressing markers that bind to these proteins would adhere to the walls of the channel. In summary, this system would allow one to input a mixture of cell and collect at the output, adult neural stem cells (cells that are larger than 12 microns and lack binding to peanut agglutinin and anti-HAS antibody).

We claim:

1. A method of separating particles, comprising:
a) providing:
i) a device comprising a sample inlet in liquid communication with a first microchannel, said first microchannel in liquid communication with a second microchannel, said second microchannel having a length and height, said height increasing along said length;
ii) a sample comprising a liquid mixture of first particles and second particles, said first and second particles being of different size; and
b) introducing said sample into said device via said sample inlet under conditions such that a stream of liquid is generated in said first microchannel and said first and second particles are separated in said second microchannel.

2. The method of claim 1, wherein said device is comprised of poly(dimethylsiloxane).

3. The method of claim 1, wherein said stream is generated by conveying said liquid sample by gravity into said first microchannel.

4. The method of claim 1, further comprising, after step b), detecting said separated particles.

5. The method of claim 1, wherein said sample comprises a biological sample.

6. The method of claim 5, wherein said biological sample comprises blood cells.

7. A method of separating particles, comprising:
a) providing:
i) a device comprising a sample inlet in liquid communication with a first microchannel, said first microchannel in liquid communication with a second microchannel, said second microchannel comprising a an adhesive sorting region defined by one or more ligands bound to said second microchannel;
ii) a sample comprising a liquid mixture of first particles and second particles, said first and second particles being of different size; and
b) introducing said sample into said device via said sample inlet under conditions such that a stream of liquid is generated in said first microchannel and said first and second particles are separated in said second microchannel.

8. The method of claim 7, wherein said device is comprised of poly(dimethylsiloxane).

9. The method of claim 7, wherein said stream is generated by conveying said liquid sample by gravity into said first microchannel.

10. The method of claim 7, further comprising, after step b), detecting said separated particles.

11. The method of claim 7, wherein said sample comprises a biological sample.

12. The method of claim 11, wherein said biological sample comprises blood cells.

13. A method of separating particles, comprising:
a) providing:
i) a device comprising a sample inlet in liquid communication with a first microchannel, said first microchannel in liquid communication with a second microchannel, said second microchannel separated from a third microchannel by a membrane, said membrane having pores;
ii) a sample comprising a liquid mixture of first particles and second particles, said first and second particles being of different size; and
b) introducing said sample into said device via said sample inlet under conditions such that a stream of liquid is generated in said first microchannel and said first and second particles are separated in said second microchannel.

14. The method of claim 13, wherein said device is comprised of poly(dimethylsiloxane).

15. The method of claim 13, wherein said stream is generated by conveying said liquid sample by gravity into said first microchannel.

16. The method of claim 13, further comprising, after step b), detecting said separated particles.

17. The method of claim 13, wherein said sample comprises a biological sample.

18. The method of claim 17, wherein said biological sample comprises blood cells.
